(19) United States
(12) Patent Application Publication
(10) Pub. No.: US 2005/0250876 A1
(43) Pub. Date: Nov. 10, 2005

(54) Ink for fabric printing, and printing method

(75) Inventors: Takashi Kawaguchi, Nagoya-shi (JP); Akiko Mizuno, Nagoya-shi (JP); Shiro Mori, Kawanishi-shi (JP)

Correspondence Address: OLIFF & BERRIDGE, PLC, P.O. BOX 19928, ALEXANDRIA, VA, 22320, US

(73) Assignees: Brother Kogyo Kabushiki Kaisha, Nagoya-shi (JP); Fuji Pigment Co., Ltd., Kawanishi-shi (JP)

(21) Appl. No.: 11/180,561

(22) Filed: Jul. 14, 2005

Related U.S. Application Data
(63) Continuation-in-part of application No. 10/773,207, filed on Feb. 9, 2004.

(30) Foreign Application Priority Data
Mar. 20, 2003 (JP) 2003-078101
May 19, 2005 (JP) 2005-147094

(51) Int. Cl. C03C 17/00; C09D 11/00

(52) U.S. Cl. 523/160; 523/161

(57) ABSTRACT

An ink for fabric printing contains a pigment and a resin emulsion. The weight ratio between the pigment and the resin emulsion by resin solid basis is between 1:0.7 and 1:3.0. A process for manufacturing printed matters has a printing step, in which printing is performed by causing the ink for fabric printing to adhere to a fabric; and a fixing step, in which the ink for fabric printing applied to the fabric in the printing step is fixed to the fabric by heating.

This is a Continuation-in-Part of application Ser. No. 10/773,207 filed Feb. 9, 2004, and now abandoned. The entire disclosure of the prior application is hereby incorporated by reference herein in its entirety.

### BACKGROUND OF THE INVENTION

1. Field of the Invention

-The present invention relates to, for example, an ink for fabric printing that is used to form an ink image on a fabric by discharging the ink by ink jet method, and to a process for manufacturing a printed matter using the ink.

2. Description of the Related Art

A printing method in which ink jet recording is employed to form an ink image on a fabric has been known in the past (see Japanese Laid-Open Patent Application H8-283636). With this printing method, first an ink containing a pigment and an resin emulsion is discharged onto a fabric by ink jet method to form the desired image, and then the pigment is fixed to the fabric by heat treatment.

Another known method for forming an image on a fabric is to form a resin layer on the surface of the fabric by coating with a plastisol ink containing a resin such as vinyl chloride.

However, with an ink jet recording method that makes use of a pigment, when the ink is fixed by heating, the pigment contained in the ink sometimes becomes inadequately fixed to the fabric, depending on properties of the resin emulsion which is used upon fixing, which is a problem in that repeated laundering of the fabric washes out the pigment and the color fades.

Meanwhile, problems encountered with a method involving coating with a plastisol ink containing a resin such as vinyl chloride are that the use of screen printing necessitates the production of a screen; the thick resin layer formed on the surface of the fabric makes the fabric feel stiff; perspiration absorbency decreases; plasticity decreases over time, causing unsightly cracks to form in the resin layer; and so on.

### SUMMARY OF THE INVENTION

The present invention was conceived in light of the above, and it is an object thereof to provide an ink for fabric printing and a process for manufacturing a printed matter using the ink with which laundering fastness is good, and the resulting fabric is excellent in terms of feel, perspiration absorbancy, appearance, and so forth.

The above object has been attained by the following present invention.

The present invention provides an ink for fabric printing, comprising a pigment and a resin emulsion, wherein the weight ratio between the pigment and the resin emulsion by solid basis is between 1:0.7 and 1:3.0, and the resin emulsion comprises a resin having a glass transition point of not less than −25° C. and not more than 18° C. and has an acid value of not less than 4 and not more than 54.

The present invention also provides a process for manufacturing a printed matter which comprises a printing step, in which printing is performed by causing the ink for fabric printing according to the present invention to adhere to a fabric, and a fixing step, in which the ink for fabric printing applied to the fabric in the printing step is fixed to the fabric by heating.

The ink for fabric printing of the present invention contains a pigment and a resin emulsion in specific amounts, where the resin emulsion contains a resin having a specific glass transition point and a specific acid value. Accordingly, printed matters with high optical densities and good laundering fastness are obtained, and a head discharge property and an intermittent discharge property both become improved.

### DESCRIPTION OF THE PREFERRED EMBODIMENTS

The present invention relates to an ink for fabric printing comprising a pigment and a resin emulsion. The weight ratio between the pigment and the resin emulsion by resin solid basis is between 1:0.7 and 1:3.0, and the resin emulsion contains a resin having a glass transition point of not less than −25° C. and not more than 18° C. and an acid value of not less than 4 and not more than 54.

The ink for fabric printing of the present invention will have high print density and good laundering fastness if the weight ratio of the resin emulsion by resin solid basis to the pigment is at least 0.7, preferably 1.0 or more. Specifically, when the ink for fabric printing of the present invention is used to print a fabric and then heat-fixed with an iron or the like, the pigment is securely fixed to the fabric by the resin emulsion, so there is less decrease in density when the fabric is laundered.

Also, if the weight ratio of the resin emulsion by resin solid basis to the pigment is 3.0 or less, head discharge and intermittent discharge will be improved when printing is performed using an ink jet printer or the like. In other words, when printing is performed, the ink can be discharged smoothly from the various nozzles of the ink jet head (head discharge is good), and when printing is recommenced after having been halted for a specific length of time, there are no nozzles on the ink jet head from which no ink is discharged (intermittent discharge is good).

Furthermore, when the ink for fabric printing of the present invention is made to adhere to a fabric, since it does not form a thick resin layer on the surface of the fabric, unlike plastisol inks containing resins such as vinyl chloride, the fabric does not feel stiff, there is no decrease in perspiration absorbancy, and the appearance of the fabric is not diminished by cracks in the resin layer.

In the ink for fabric printing of the present invention, the resin emulsion contains a resin having a glass transition point of not less than −25° C. and not more than 18° C., and an acid value of not less than 4 and not more than 54. The glass transition point can be measured using a differential scanning calorimeter, and the acid value is the amount [mg] of potassium hydroxide required to neutralize free aliphatic acids or free fatty acids contained in 1 g of resin.

In the present invention, when the glass transition point of the resin contained in the resin emulsion is not less than −25° C. and not more than 18° C., stiffness and tackiness of fabric surface after fixing can be balanced with fixability of ink to fibers. When the acid value of the resin is not less than 4 and not more than 54, an emulsion stability in ink and laundering fastness can go together.

Examples of the above-mentioned resin emulsion include acrylic resin emulsions, vinyl acetate resin emulsions, urethane resin emulsions, polyester resin emulsions, silicone resin emulsions, olefin resin emulsions, and the like. Examples of the resins contained in the above-mentioned resin emulsions include acrylic resins, vinyl acetate resins, urethane resins, polyester resins, silicone resins, olefin resins, and the like.

Examples of the above-mentioned pigment include black (carbon black; C.I. Pigment Black 7), yellow (monoazo yellow; C.I. Pigment Yellow 74), cyan (phthalocyanine blue; C.I. Pigment Blue 15:3), magenta (quinacridone red; C.I. Pigment Red 122), and the like.

Examples of the above-mentioned fabric include cotton, polyester, and cotton/polyester blends.

The ink for fabric printing of the present invention can also contain other components such as pigment dispersants, water-soluble organic solvents, surfactants, and pH regulators.

Examples of pigment dispersants include acrylic acid copolymers. The amount added thereof is from 0.2 to 8 wt %, for example.

The water-soluble organic solvent is a component for regulating viscosity and prevent water evaporation, and examples include glycerin, ethylene glycol, diethylene glycol, and propylene glycol. The amount added thereof is from 10 to 60 wt %, for example.

The surfactant is a component for regulating the surface tension of the ink for fabric printing, and examples include acetylene glycol, alkylphenol ethylene oxide adducts, alkylbenzenesulfonates, sorbitan fatty acid esters, and the like. The amount added thereof is from 0.01 to 5 wt %, for example.

The pH regulator is a component for fine-tunning and maintaining the pH, and examples include triethanolamine, diethanolamine, tris(hydroxymethyl)aminomethane, sodium carbonate, and the like. The amount added thereof is from 0.01 to 5 wt %, for example.

In the present invention, as the resin emulsions, there can be used those which are produced by known processes for manufacturing resin emulsions, preferably those in which particles of the resin emulsions are produced in liquid, for examples produced by emulsion polymerization.

When the resin emulsion particles contained in the ink for fabric printing of the present invention are produced in the liquid, these particles are spherical, or at least have a roundish shape. The result is that the ink for fabric printing of the present invention has the effect of allowing stable discharge from an ink jet head even when the solid concentration in the resin emulsion is increased.

Accordingly, in the ink for fabric printing of the present invention, it is preferable that the particles of the resin emulsion are spherical. The word “spherical” as used here means that the ratio of major diameter to minor diameter of the spherical particles is between 1:1 and 1:0.7 when measured using a scanning electron microscope, for example.

Examples of how the particles of resin emulsion can be produced in the liquid include emulsion polymerization, suspension polymerization, and a method in which a solution in which a resin component has been dissolved is quickly added dropwise into water to produce resin emulsion particles.

The ink for fabric printing of the present invention can preferably apply to a process for manufacturing printed matters. Specifically, the present invention also provides a process for manufacturing printed matters, comprising a printing step, in which printing is performed by causing the ink for fabric printing according to the present invention to adhere to a fabric, and a fixing step, in which the ink for fabric printing applied to the fabric in the printing step is fixed to the fabric by heating.

Also, because the process of manufacturing printed matters of the present invention includes a fixing step, the fixability of the pigment and resin emulsion to the fabric is improved, and laundering fastness is even better.

Furthermore, since the use of an plastisol ink containing a resin such as vinyl chloride is not required with the process for manufacturing printed matters of the present invention, no thick resin layer is formed on the surface of the fabric, the fabric does not feel stiff, there is no decrease in perspiration absorbancy, and the appearance of the fabric is not diminished by cracks in the resin layer.

In the above-mentioned printing step, the ink for fabric printing can be made to adhere to the fabric by using an ink jet head, a fabric conveyance apparatus, and so forth, for example.

In the above-mentioned fixing step, the heating can be accomplished with an iron, for example. The heating temperature is at least 150° C., for example, so that the pigment and resin emulsion can be sufficiently fixed to the fabric, but the temperature should not be so high that the fabric is damaged. A heating time of at least 30 seconds is favorable.

### DESCRIPTION OF THE PREFERRED EMBODIMENTS

Embodiments (examples) of the ink for fabric printing of the present invention will now be described.

### EXAMPLE 1

a) The method for manufacturing the ink for fabric printing will be described.

The following components were mixed in their respective proportions, and the resulting mixture was dispersed and stirred by use of a sand mill and a stirrer to manufacture inks for fabric printing of Examples 1-1 to 1-8. Table 1 shows the carbon black concentration (A), the resin emulsion concentration (B), and the ratio B/A thereof for the inks for fabric printing of Examples 1-1 to 1-8 and of aftermentioned Comparative Examples 1-1 to 1-9.

The resin emulsions contained in the inks for fabric printing of Examples 1-1 to 1-8 were manufactured by emulsion polymerization, and the emulsion particles thereof were spherical. In the various inks for fabric printing, the balance other than the components listed below was pure water.

TABLE 1

| | | Pigment | Emulsion | | | | | | |
|---|---|---|---|---|---|---|---|---|---|
| | | concen- | concen- | | | | | | Visual |
| | | tration | tration by | | | | OD value | | comparison |
| | | (A) | solid basis | B/A | Head | Intermittent | Before | After | before and after |
| | | (wt %) | (B) (wt %) | ratio | discharge | discharge | laundering | laundering | laundering |
| Ex. | 1-1 | 8 | 6 | 0.75 | good | good | 1.15 | 1.00 | good |
| | 1-2 | 8 | 7 | 0.88 | good | good | 1.20 | 1.05 | good |
| | 1-3 | 8 | 8 | 1.00 | good | good | 1.20 | 1.10 | excellent |
| | 1-4 | 8 | 9 | 1.13 | good | good | 1.20 | 1.10 | excellent |
| | 1-5 | 8 | 10 | 1.25 | good | good | 1.20 | 1.10 | excellent |
| | 1-6 | 8 | 16 | 2.00 | good | good | 1.25 | 1.20 | excellent |
| | 1-7 | 8 | 20 | 2.50 | good | good | 1.25 | 1.25 | excellent |
| | 1-8 | 8 | 24 | 3.00 | good | good | 1.25 | 1.25 | excellent |
| CE | 1-1 | 5 | 0 | 0 | good | good | 0.80 | 0.40 | poor |
| | 1-2 | 6 | 0 | 0 | good | good | 0.85 | 0.40 | poor |
| | 1-3 | 7 | 0 | 0 | good | good | 0.90 | 0.40 | poor |
| | 1-4 | 8 | 0 | 0 | good | good | 1.00 | 0.50 | poor |
| | 1-5 | 8 | 5 | 0.63 | good | good | 1.10 | 0.90 | poor |
| | 1-6 | 8 | 25 | 3.13 | good | poor | 1.30 | 1.25 | excellent |
| | 1-7 | 8 | 26 | 3.25 | good | poor | 1.30 | 1.25 | excellent |
| | 1-8 | 8 | 27 | 3.38 | poor | poor | 1.00 | 1.00 | excellent |
| | 1-9 | 8 | 28 | 3.50 | poor | poor | 0.90 | 0.90 | excellent |

[Ex.: Examples;
CE: Comparative Examples]

### Example 1-1

Carbon black^{*1}: 8 wt %
   (Raven 1250 (Pigment Black 7), pigment; available from Columbian Carbon Japan Limited)
Acrylic acid copolymer 2: 1.6 wt %
   (Joncryl 678, pigment dispersant; available from Johnson Polymer, Inc.)
Acrylic resin emulsion^{*3}: 6 wt % (by solid basis)
   (Newcoat #1182; available from Shin-Nakamura Chemical Co., Ltd.)
Diethylene glycol (water-soluble organic solvent): 20 wt %
Acetylene glycol (surfactant): 0.1 wt %
Triethanolamine (pH regulator): 0.1 wt %

### Example 1-2

Carbon black^{*1}: 8 wt %
Acrylic acid copolymer^{*2}: 1.6 wt %
Acrylic resin emulsion^{*3}: 7 wt % (by solid basis)
Diethylene glycol (water-soluble organic solvent): 20 wt %
Acetylene glycol (surfactant): 0.1 wt %
Triethanolamine (pH regulator): 0.1 wt %

### Example 1-3

Carbon black^{*1}: 8 wt %
Acrylic acid copolymer^{*2}: 1.6 wt %
Acrylic resin emulsion^{*3}: 8 wt % (by solid basis)
Diethylene glycol (water-soluble organic solvent): 20 wt %
Acetylene glycol (surfactant): 0.1 wt %
Triethanolamine (pH regulator): 0.1 wt %

### Example 1-4

Carbon black^{*1}: 8 wt %
Acrylic acid copolymer^{*2}: 1.6 wt %
Acrylic resin emulsion^{*3}: 9 wt % (by solid basis)
Diethylene glycol (water-soluble organic solvent): 20 wt %
Acetylene glycol (surfactant): 0.1 wt %
Triethanolamine (pH regulator): 0.1 wt %

### Example 1-5

Carbon black^{*1}: 8 wt %
Acrylic acid copolymer^{*2}: 1.6 wt %
Acrylic resin emulsion^{*3}: 10 wt % (by solid basis)
Diethylene glycol (water-soluble organic solvent): 20 wt %
Acetylene glycol (surfactant): 0.1 wt %
Triethanolamine (pH regulator): 0.1 wt %

### Example 1-6

Carbon black^{*1}: 8 wt %
Acrylic acid copolymer^{*2}: 1.6 wt %
Acrylic resin emulsion^{*3}: 16 wt % (by solid basis)
Diethylene glycol (water-soluble organic solvent): 20 wt %
Acetylene glycol (surfactant): 0.1 wt %
Triethanolamine (pH regulator): 0.1 wt %

### Example 1-7

Carbon black^{*1}: 8 wt %
Acrylic acid copolymer^{*2}: 1.6 wt %
Acrylic resin emulsion^{*3}: 20 wt % (by solid basis)
Diethylene glycol (water-soluble organic solvent): 20 wt %
Acetylene glycol (surfactant): 0.1 wt %
Triethanolamine (pH regulator): 0.1 wt %

### Example 1-8

Carbon black^{*1}: 8 wt %
Acrylic acid copolymer^{*2}: 1.6 wt %
Acrylic resin emulsion^{*3}: 24 wt % (by solid basis)
Diethylene glycol (water-soluble organic solvent): 20 wt %
Acetylene glycol (surfactant): 0.1 wt %
Triethanolamine (pH regulator): 0.1 wt %

As comparative examples, the components listed below were mixed in their respective proportions, and the resulting mixture was dispersed and stirred by use of a sand mill and a stirrer to manufacture inks for fabric printing of Comparative Examples 1-1 to 1-9. The resin emulsions contained in the inks for fabric printing were manufactured by emulsion polymerization, and the emulsion particles thereof were spherical. In the various inks for fabric printing, the balance other than the components listed below was pure water.

### Comparative Example 1-1

Carbon black^{*1}: 5 wt %
Acrylic acid copolymer^{*2}: 1.0 wt %
Diethylene glycol (water-soluble organic solvent): 20 wt %
Acetylene glycol (surfactant): 0.1 wt %
Triethanolamine (pH regulator): 0.1 wt %

### Comparative Example 1-2

Carbon black^{*1}: 6 wt %
Acrylic acid copolymer^{*2}: 1.2 wt %
Diethylene glycol (water-soluble organic solvent): 20 wt %
Acetylene glycol (surfactant): 0.1 wt %
Triethanolamine (pH regulator): 0.1 wt %

### Comparative Example 1-3

Carbon black^{*1}: 7 wt %
Acrylic acid copolymer^{*2}: 1.4 wt %
Diethylene glycol (water-soluble organic solvent): 20 wt %
Acetylene glycol (surfactant): 0.1 wt %
Triethanolamine (pH regulator): 0.1 wt %

### Comparative Example 1-4

Carbon black^{*1}: 8 wt %
Acrylic acid copolymer^{*2}: 1.6 wt %
Diethylene glycol (water-soluble organic solvent): 20 wt %
Acetylene glycol (surfactant): 0.1 wt %
Triethanolamine (pH regulator): 0.1 wt %

### Comparative Example 1-5

Carbon black^{*1}: 8 wt %
Acrylic acid copolymer^{*2}: 1.6 wt %
Acrylic resin emulsion^{*3}: 5 wt % (by solid basis)
Diethylene glycol (water-soluble organic solvent): 20 wt %
Acetylene glycol (surfactant): 0.1 wt %
Triethanolamine (pH regulator): 0.1 wt %

### Comparative Example 1-6

Carbon black^{*1}: 8 wt %
Acrylic acid copolymer^{*2}: 1.6 wt %
Acrylic resin emulsion^{*3}: 25 wt % (by solid basis)
Diethylene glycol (water-soluble organic solvent): 20 wt %
Acetylene glycol (surfactant): 0.1 wt %
Triethanolamine (pH regulator): 0.1 wt %

### Comparative Example 1-7

Carbon black^{*1}: 8 wt %
Acrylic acid copolymer^{*2}: 1.6 wt %
Acrylic resin emulsion^{*3}: 26 wt % (by solid basis)
Diethylene glycol (water-soluble organic solvent): 20 wt %
Acetylene glycol (surfactant): 0.1 wt %
Triethanolamine (pH regulator): 0.1 wt %

### Comparative Example 1-8

Carbon black^{*1}: 8 wt %
Acrylic acid copolymer^{*2}: 1.6 wt %
Acrylic resin emulsion^{*3}: 27 wt % (by solid basis)
Diethylene glycol (water-soluble organic solvent): 20 wt %
Acetylene glycol (surfactant): 0.1 wt %
Triethanolamine (pH regulator): 0.1 wt %

### Comparative Example 1-9

Carbon black^{*1}: 8 wt %
Acrylic acid copolymer^{*2}: 1.6 wt %
Acrylic resin emulsion^{*3}: 28 wt % (by solid basis)
Diethylene glycol (water-soluble organic solvent): 20 wt %
Acetylene glycol (surfactant): 0.1 wt %
Triethanolamine (pH regulator): 0.1 wt %

The ratios of the resin emulsion content to the pigment content in Comparative Examples 1-1 to 1-5 were less than 0.7 and therefore outside the range of the present invention. In Comparative Examples 1-6 to 1-9, the ratios of the resin emulsion content to the pigment content were over 3.0 and therefore outside the range of the present invention.

b) Next, a process for manufacturing printed matters in which a fabric is printed using the inks for fabric printing of Example 1 will be described.

100% cotton fabric was printed at 50 pl×600 dpi with a Brother IJ printer (printing step).

Next, an iron was used to heat the printed portion for 40 seconds at a temperature of 180° C. and thereby fix the ink for fabric printing to the fabric (fixing step).

c) Next, the effects of the inks for fabric printing of Example 1 and the above process for manufacturing printed matters will be described.

(i) The inks for fabric printing of Example 1 has good laundering fastness because the weight ratio of the resin emulsion (by solid basis) to the pigment is at least 0.7. That is, when the ink for fabric printing of this example is used to print a fabric and heat-fixed with an iron or the like, the pigment is securely affixed to the fabric, so there is little decrease in density when the fabric is laundered. The print density is also high (1.15 or higher).

(ii) Because the weight ratio of the resin emulsion (by solid basis) to the pigment is no more than 3.0 in the inks for fabric printing of Example 1, head discharge and intermittent discharge are both good during printing with an ink jet printer.

Specifically, when printing is performed, the ink can be discharged smoothly from the various nozzles of the ink jet head (head discharge is good), and when printing is recommenced after having been halted for a specific length of time, there are no nozzles on the ink jet head from which no ink is discharged (intermittent discharge is good).

(iii) Because the inks for fabric printing of Example 1 does not form a thick resin layer on the surface of the fabric, unlike plastisol inks containing resins containing a resin such as vinyl chloride, the fabric does not feel stiff, there is no decrease in perspiration absorbancy, and the appearance of the fabric is not diminished by cracks in the resin layer.

d) Next, we will describe an experiment conducted in order to confirm the effects of the inks for fabric printing of Example 1 and the above-mentioned process for manufacturing printed matters.

(i) Test of Laundering Fastness

The laundering fastness test was carried out according to AATCC 135-1995 IIIA. Specifically, first a 100% cotton fabric was printed in the same manner as in b) above, using the inks for fabric printing from Examples 1-1 to 1-8 and Comparative Examples 1-1 to 1-9. The density of the printed portion was then measured with a Macbeth densitometer (density before laundering).

This fabric was then laundered according to AATCC 135-1995 IIIA, and the density after laundering was measured by the same method as above (density after laundering). These results are given in Table 1.

As shown in Table 1, when the inks for fabric printing of Examples 1-1 to 1-8 were used, the difference in density before and after laundering was 0.15 or less, and the print density after laundering was over 1.0, which confirms that the laundering fastness was good. In contrast, when the inks for fabric printing in Comparative Examples 1-1 to 1-5 were used, the difference in density before and after laundering was 0.2 or greater, and the print density after laundering was less than 1.0, so laundering fastness was poor.

(ii) Head Discharge Test

A surface area equal to 10 sheets of A4-size paper was printed using the inks for fabric printing from Examples 1-1 to 1-8 and Comparative Examples 1-1 to 1-9. The type of printer used and the printing conditions were the same as in b) above.

The head discharge here was considered to be “good” if there was no abnormal printing within the printed area, but “poor” if there was any abnormal printing. “Abnormal printing” as used here means that no ink was discharged from one or more of the nozzles of the ink jet head, or that ink adhered somewhere other than where it was supposed to adhere. The results of evaluating head discharge are given in the above-mentioned Table 1.

As shown in Table 1, when the inks for fabric printing of Examples 1-1 to 1-8 were used, head discharge was rated “good” in every case. These results confirm that the inks for fabric printing of Examples 1-1 to 1-8 are discharged well from the head. In contrast, the evaluation was “poor” when the inks for fabric printing in Comparative Examples 1-8 and 1-9 were used.

(iii) Intermittent Discharge Test

A surface area equal to 1 sheet of A4-size paper was printed using the inks for fabric printing from Examples 1-1 to 1-8 and Comparative Examples 1-1 to 1-9, after which the product was allowed to stand for 15 minutes, and then printing was again performed over an area equal to 1 sheet of A4-size paper. The type of printer used and the printing conditions were the same as in b) above.

The intermittent discharge was considered to be “good” if there was no abnormal printing on the paper printed after a pause of 15 minutes, but “poor” if there was any abnormal printing. The results of evaluating intermittent discharge are given in the above-mentioned Table 1.

As shown in Table 1, when the inks for fabric printing of Examples 1-1 to 1-8 were used, intermittent discharge was rated “good” in every case. These results confirm that the inks for fabric printing of Examples 1-1 to 1-8 are intermittently discharged well from the head.

In contrast, the intermittent discharge was rated “poor” when the inks for fabric printing in Comparative Examples 1-6 to 1-9 were used.

(iv) Visual Comparison Test Before and After Laundering

The printed portion was examined visually before and after the laundering in (i) above. These results are given in Table 1.

As shown in Table 1, when the inks for fabric printing of Examples 1-1 to 1-8 were used, there was no change whatsoever in the appearance of the fabric before and after laundering (“excellent” rating), or there was almost no change (“good” rating).

In contrast, in Comparative Examples 1-1 to 1-5, the printed portion of the laundered fabric had developed pilling and turned white (“poor” rating).

### Examples 1-3, 1-3a to 1-3g and Comparative Examples 1-3a to 1-3e

With respect to Example 1-3 which is a typical example of Examples 1-1 to 1-8, in order to evaluate how laundering properties are influenced by glass transition points and acid values of the resins of the resin emulsions, the inks for fabric printing of Examples 1-3a to 1-8g and Comparative Examples 1-3a to 1-3e were prepared repeating the operations of Example 1-3, except for using resin emulsions shown in Table 2, and the items “OD values before or after laundering” and “Visual comparison test before and after laundering” were evaluated similarly in case of Example 1-3. The results obtained are shown in Table 2. The glass transition points were measured using a differential scanning calorimeter, and the acid values were the amount [mg] of potassium hydroxide required for neutralizing free aliphatic acids or free fatty acids contained in 1 g [resin solid content] of the resin emulsion.

The inks of fabric printing resins contained in the acrylic resin emulsions of Examples 1-3 were the same as those of Examples 1-3a to 1-3g and Comparative Examples 1-3a to 1-3e. The ink compositions and the processes for manufacturing the inks of Examples 1-3 were also the same as those of Examples 1-3a to 1-3g and Comparative Examples 1-3a to 1-3e, except that the glass transition points (Tg) and acid values thereof are shown in Table 2. Accordingly, the pigment concentration (A) was 8 wt % and the resin emulsion concentration by resin solid basis (B) was 8 wt %, and then the ratio of (B)/(A) was 1.00.

TABLE 2

| | | | Acid | | | Visual com- |
|---|---|---|---|---|---|---|
| | | | value | | | parison |
| | | | (KOH | OD value | | before and |
| | | Tg ° C. | mg) | Before | After | after laundering |
| Ex. | 1-3 | −25 | 4 | 1.20 | 1.10 | Excellent |
| | 1-3a | −5 | 54 | 1.15 | 1.10 | Excellent |
| | 1-3b | −4 | 4 | 1.15 | 1.05 | Excellent |
| | 1-3c | 0 | 8 | 1.30 | 1.20 | Excellent |
| | 1-3d | 9 | 13 | 1.30 | 1.20 | Excellent |
| | 1-3e | 9 | 54 | 1.25 | 1.10 | Good |
| | 1-3f | 16 | 51 | 1.30 | 1.25 | Excellent |
| | 1-3g | 18 | 13 | 1.15 | 1.00 | Good |
| CE. | 1-3a | 0 | 100 | 1.20 | 1.00 | Poor |
| | 1-3b | 12 | 87 | 0.90 | 0.55 | Poor |
| | 1-3c | 16 | 100 | 1.15 | 0.95 | Poor |
| | 1-3d | 22 | >60 | 1.15 | 0.70 | Poor |
| | 1-3e | 50 | 7 | 1.20 | 1.00 | Poor |

As is apparent from the Table 2, when using the resin emulsions with a glass transition point of −25° C. to 18° C. and an acid value of 4 to 54, good results were obtained with respect to the “OD value” and the “Visual comparison before and after laundering”. To the contrary, if at least either of a glass transition point and an acid value will vary from the range, insufficient results were obtained.

### EXAMPLE 2

a) The following components were mixed in their respective proportions, and the resulting mixture was dispersed and stirred by use of a sand mill and a stirrer to manufacture inks for fabric printing of Examples 2-1 to 2-8. Table 3 shows the pigment concentration (A), the resin emulsion concentration (B), and the ratio B/A thereof for the inks for fabric printing of Examples 2-1 to 2-8 and of aftermentioned Comparative Examples 2-1 to 2-9.

The resin emulsions contained in the inks for fabric printing of Examples 2-1 to 2-8 were manufactured by emulsion polymerization, and the emulsion particles thereof were spherical. In the various inks for fabric printing, the balance other than the components listed below was pure water.

TABLE 3

| | | Pigment | Emulsion | | | | | | |
|---|---|---|---|---|---|---|---|---|---|
| | | concen- | concen- | | | | | | Visual |
| | | tration | tration by | | | | OD value | | comparison |
| | | (A) | solid basis | B/A | Head | Intermittent | Before | After | before and after |
| | | (wt %) | (B) (wt %) | ratio | discharge | discharge | laundering | laundering | laundering |
| Ex. | 2-1 | 3 | 2.1 | 0.70 | good | good | 0.97 | 0.90 | good |
| | 2-2 | 3 | 2.4 | 0.80 | good | good | 0.98 | 0.94 | good |
| | 2-3 | 3 | 2.7 | 0.90 | good | good | 1.00 | 0.94 | excellent |
| | 2-4 | 3 | 3 | 1.00 | good | good | 1.00 | 0.95 | excellent |
| | 2-5 | 3 | 3.3 | 1.10 | good | good | 1.00 | 0.95 | excellent |
| | 2-6 | 3 | 6 | 2.00 | good | good | 1.05 | 1.05 | excellent |
| | 2-7 | 3 | 7.5 | 2.50 | good | good | 1.05 | 1.05 | excellent |
| | 2-8 | 3 | 9 | 3.00 | good | good | 1.10 | 1.10 | excellent |
| CE | 2-1 | 1 | 0 | 0 | good | good | 0.54 | 0.30 | poor |
| | 2-2 | 1.5 | 0 | 0 | good | good | 0.70 | 0.30 | poor |
| | 2-3 | 2 | 0 | 0 | good | good | 0.76 | 0.40 | poor |
| | 2-4 | 2.5 | 0 | 0 | good | good | 0.80 | 0.50 | poor |
| | 2-5 | 3 | 1.5 | 0.50 | good | good | 0.90 | 0.70 | poor |
| | 2-6 | 3 | 10 | 3.33 | good | poor | 1.10 | 1.10 | excellent |
| | 2-7 | 3 | 15 | 5.00 | good | poor | 1.10 | 1.10 | excellent |
| | 2-8 | 3 | 20 | 6.67 | poor | poor | 1.00 | 1.00 | excellent |
| | 2-9 | 3 | 25 | 8.33 | poor | poor | 0.90 | 0.90 | excellent |

### Example 2-1

Monoazo yellow^{*4}: 3 wt %
   (Symuler Fast Yallow 4190 (Pigment Yellow 74), pigment; available from Dainippon Ink and Chemicals, Incoporated)
Acrylic acid copolymer^{*2}: 0.6 wt %
Urethane resin emulsion^{*5}: 2.1 wt % (by solid basis)
   (Yodozol RD20, available from Nippon NSC Ltd.)
Diethylene glycol (water-soluble organic solvent): 20 wt %
Acetylene glycol (surfactant): 0.1 wt %
Triethanolamine (pH regulator): 0.1 wt %

### Example 2-2

Monoazo yellow^{*4}: 3 wt %
Acrylic acid copolymer^{*2}: 0.6 wt %
Urethane resin emulsion^{*5}: 2.4 wt % (by solid basis)
Diethylene glycol (water-soluble organic solvent): 20 wt %
Acetylene glycol (surfactant): 0.1 wt %
Triethanolamine (pH regulator): 0.1 wt %

### Example 2-3

Monoazo yellow^{*4}: 3 wt %
Acrylic acid copolymer^{*2}: 0.6 wt %
Urethane resin emulsion^{*5}: 2.7 wt % (by solid basis)
Diethylene glycol (water-soluble organic solvent): 20 wt %
Acetylene glycol (surfactant): 0.1 wt %
Triethanolamine (pH regulator): 0.1 wt %

### Example 2-4

Monoazo yellow^{*4}: 3 wt %
Acrylic acid copolymer^{*2}: 0.6 wt %
Urethane resin emulsion^{*5}: 3 wt % (by solid basis)
Diethylene glycol (water-soluble organic solvent): 20 wt %
Acetylene glycol (surfactant): 0.1 wt %
Triethanolamine (pH regulator): 0.1 wt %

### Example 2-5

Monoazo yellow^{*4}: 3 wt %
Acrylic acid copolymer^{*2}: 0.6 wt %
Urethane resin emulsion^{*5}: 3.3 wt % (by solid basis)
Diethylene glycol (water-soluble organic solvent): 20 wt %
Acetylene glycol (surfactant): 0.1 wt %
Triethanolamine (pH regulator): 0.1 wt %

### Example 2-6

Monoazo yellow^{*4}: 3 wt %
Acrylic acid copolymer^{*2}: 0.6 wt %
Urethane resin emulsion^{*5}: 6 wt % (by solid basis)
Diethylene glycol (water-soluble organic solvent): 20 wt %
Acetylene glycol (surfactant): 0.1 wt %
Triethanolamine (pH regulator): 0.1 wt %

### Example 2-7

Monoazo yellow^{*4}: 3 wt %
Acrylic acid copolymer^{*2}: 0.6 wt %
Urethane resin emulsion 7.5 wt % (by solid basis)
Diethylene glycol (water-soluble organic solvent): 20 wt %
Acetylene glycol (surfactant): 0.1 wt %
Triethanolamine (pH regulator): 0.1 wt %

### Example 2-8

Monoazo yellow^{*4}: 3 wt %
Acrylic acid copolymer^{*2}: 0.6 wt %
Urethane resin emulsion 9 wt % (by solid basis)
Diethylene glycol (water-soluble organic solvent): 20 wt %
Acetylene glycol (surfactant): 0.1 wt %
Triethanolamine (pH regulator): 0.1 wt %

As comparative examples, the components listed below were mixed in their respective proportions, and the resulting mixture was dispersed and stirred by use of a sand mill and a stirrer to manufacture inks for fabric printing of Comparative Examples 2-1 to 2-9.

### Comparative Example 2-1

Monoazo yellow^{*4}: 1 wt %
Acrylic acid copolymer^{*2}: 0.2 wt %
Diethylene glycol (water-soluble organic solvent): 20 wt %
Acetylene glycol (surfactant): 0.1 wt %
Triethanolamine (pH regulator): 0.1 wt %

### Comparative Example 2-2

Monoazo yellow^{*4}: 1.5 wt %
Acrylic acid copolymer^{*2}: 0.3 wt %
Diethylene glycol (water-soluble organic solvent): 20 wt %
Acetylene glycol (surfactant): 0.1 wt %
Triethanolamine (pH regulator): 0.1 wt %

### Comparative Example 2-3

Monoazo yellow^{*4}: 2 wt %
Acrylic acid copolymer^{*2}: 0.4 wt %
Diethylene glycol (water-soluble organic solvent): 20 wt %
Acetylene glycol (surfactant): 0.1 wt %
Triethanolamine (pH regulator): 0.1 wt %

### Comparative Example 2-4

Monoazo yellow^{*4}: 2.5 wt %
Acrylic acid copolymer^{*2}: 0.5 wt %
Diethylene glycol (water-soluble organic solvent): 20 wt %
Acetylene glycol (surfactant): 0.1 wt %
Triethanolamine (pH regulator): 0.1 wt %

### Comparative Example 2-5

Monoazo yellow^{*4}: 3 wt %
Acrylic acid copolymer^{*2}: 0.6 wt %
Urethane resin emulsion^{*5}: 1.5 wt % (by solid basis)
Diethylene glycol (water-soluble organic solvent): 20 wt %
Acetylene glycol (surfactant): 0.1 wt %
Triethanolamine (pH regulator): 0.1 wt %

### Comparative Example 2-6

Monoazo yellow^{*4}: 3 wt %
Acrylic acid copolymer^{*2}: 0.6 wt %
Urethane resin emulsion^{*5}: 10 wt % (by solid basis)
Diethylene glycol (water-soluble organic solvent): 20 wt %
Acetylene glycol (surfactant): 0.1 wt %
Triethanolamine (pH regulator): 0.1 wt %

### Comparative Example 2-7

Monoazo yellow^{*4}: 3 wt %
Acrylic acid copolymer^{*2}: 0.6 wt %
Urethane resin emulsion^{*5}: 15 wt % (by solid basis)
Diethylene glycol (water-soluble organic solvent): 20 wt %
Acetylene glycol (surfactant): 0.1 wt %
Triethanolamine (pH regulator): 0.1 wt %

### Comparative Example 2-8

Monoazo yellow^{*4}: 3 wt %
Acrylic acid copolymer^{*4}: 0.6 wt %
Urethane resin emulsion^{*5}: 20 wt % (by solid basis)
Diethylene glycol (water-soluble organic solvent): 20 wt %
Acetylene glycol (surfactant): 0.1 wt %
Triethanolamine (pH regulator): 0.1 wt %

### Comparative Example 2-9

Monoazo yellow^{*4}: 3 wt %
Acrylic acid copolymer^{*2}: 0.6 wt %
Urethane resin emulsion^{*5}: 25 wt % (by solid basis)
Diethylene glycol (water-soluble organic solvent): 20 wt %
Acetylene glycol (surfactant): 0.1 wt %
Triethanolamine (pH regulator): 0.1 wt %

The ratios of the resin emulsion content to the pigment content in Comparative Examples 2-1 to 2-5 were less than 0.7 and therefore outside the range of the present invention. In Comparative Examples 2-6 to 2-9, the ratios of the resin emulsion content to the pigment content were over 3.0 and therefore outside the range of the present invention.

b) Next, fabric was printed by the same process for manufacturing printed matters as in Example 1 above, but using the inks for fabric printing of Example 2.

c) The inks for fabric printing of Example 2 and the process for manufacturing printed matters using these inks had the same effects as in Example 1 above.

d) Laundering fastness, head discharge, intermittent discharge, and appearance before and after laundering were then tested in the same manner as in d) in Example 1 above in order to confirm the effects of the inks for fabric printing of Example 2 and the above-mentioned printing method. These results are given in the above-mentioned Table 3.

(i) Test of Laundering Fastness

As shown in Table 3, when the inks for fabric printing of Examples 2-1 to 2-8 were used, the difference in density before and after laundering was 0.07 or less, and the print density after laundering was at least 0.9, which confirms that the laundering fastness was good.

In contrast, when the inks for fabric printing in Comparative Examples 2-1 to 2-5 were used, the difference in density before and after laundering was 0.2 or greater, and the print density after laundering was less than 0.7, so laundering fastness was poor.

(ii) Head Discharge Test

As shown in Table 3, when the inks for fabric printing of Examples 2-1 to 2-8 were used, head discharge was rated “good” in every case. These results confirm that the inks for fabric printing of Examples 2-1 to 2-8 are discharged well from the head.

In contrast, the evaluation was “poor” when the inks for fabric printing in Comparative Examples 2-8 and 2-9 were used.

(iii) Intermittent Discharge Test

As shown in Table 3, when the inks for fabric printing of Examples 2-1 to 2-8 were used, intermittent discharge was rated “good” in every case. These results confirm that the inks for fabric printing of Examples 2-1 to 2-8 are intermittently discharged well from the head.

In contrast, the intermittent discharge was rated “poor” when the inks for fabric printing in Comparative Examples 2-6 to 2-9 were used.

(iv) Visual Comparison Test Before and After Laundering

As shown in Table 3, when the inks for fabric printing of Examples 2-1 to 2-8 were used, there was no change whatsoever in the appearance of the fabric before and after laundering (“excellent” rating), or there was almost no change (“good” rating).

In contrast, in Comparative Examples 2-1 to 2-5, the printed portion of the laundered fabric had developed pilling and turned white (“poor” rating).

The preferable glass transition points and acid values in the resin emulsion used in this Example were the same as those in Examples 1-3 or Examples 1-3a to 1-3g.

### EXAMPLE 3

Other than changing the type of pigment to phthalocyanine blue (Fastogen blue TGR (Pigment Blue 15:3); available from Dainippon Ink and Chemicals, Incorporated), inks for fabric printing 3-1 to 3-8 were manufactured in the same manner as the inks for fabric printing of Examples 2-1 to 2-8.

The same tests as in d) of Example 1 above were conducted using these inks for fabric printing 3-1 to 3-8, whereupon the results were the same as for the inks for fabric printing of Examples 2-1 to 2-8. The preferable glass transition points and acid values in the resin emulsion used in this Example were the same as those in Examples 1-3 or Examples 1-3a to 1-3g.

### EXAMPLE 4

Other than changing the type of pigment to quinacridone red (Toner Magenta E02 (Pigment Red 122); available from Clariant Japan Co., Ltd.), the inks for fabric printing 4-1 to 4-8 were manufactured in the same manner as the inks for fabric printing of Examples 2-1 to 2-8.

The same tests as in d) of Example 1 above were conducted using these inks for fabric printing 4-1 to 4-8, whereupon the results were the same as for the inks for fabric printing of Examples 2-1 to 2-8.

The preferable glass transition points and acid values in the resin emulsion used in this Example were the same as those in Examples 1-3 or Examples 1-3a to 1-3g.

The present invention is not limited in any way to or by the above examples, and it should go without saying that various other embodiments are possible within the scope of the present invention.

The entire disclosures of the specifications, claims and summaries of Japanese Patent Application Nos. 2003-78101 filed Mar. 20, 2003 and 2005-147094 filed May 19, 2005 are hereby incorporated by reference herein in their entirety.

1. An ink for fabric printing, comprising a pigment and a resin emulsion,
wherein the weight ratio between the pigment and the resin emulsion by resin solid basis is between 1:0.7 and 1:3.0, and the resin emulsion comprises a resin having glass transition point of not less than −25° C. to not more than 18° C. and an acid value of not less than 4 and not more than 54.

2. The ink for fabric printing according to claim 1, wherein the weight ratio between the pigment and the resin emulsion by resin solid basis is between 1:1.0 and 1:3.0.

3. The ink for fabric printing according to claim 1 or 2, wherein the particles of the resin emulsion are produced in the liquid.

4. The ink for fabric printing according to claim 1, wherein the particles of the resin emulsion are spherical.

5. The ink for fabric printing according to claim 1, wherein the resin emulsion is acrylic resin emulsions, vinyl acetate resin emulsions, urethane resin emulsions, polyester resin emulsions, silicone resin emulsions, or olefin resin emulsions.

6. The ink for fabric printing according to claim 1, wherein the pigment is C.I. Pigment Black 7, C.I. Pigment Yellow 74, C.I. Pigment Blue 15:3 or C.I. Pigment Red 122.

7. The ink for fabric printing according to claim 1, further comprising pigment dispersants including acrylic acid copolymers in an amount of 0.2 to 8 wt %, for example.

8. The ink for fabric printing according to claim 1, further comprising a water-soluble organic solvent in an amount of from 10 to 60 wt %.

9. The ink for fabric printing according to claim 8, wherein the water-soluble organic solvent is selected from the group consisting of glycerin, ethylene glycol, diethylene glycol and propylene glycol.

10. The ink for fabric printing according to claim 1, further comprising a surfactant in an amount of from 0.01 to 5 wt %.

11. The ink for fabric printing according to claim 1, wherein the surfactant is selected from the group consisting of acetylene glycol, alkylphenol ethylene oxide adducts, alkylbenzenesulfonates, and sorbitan fatty acid esters.

12. The ink for fabric printing according to claim 1, further comprising a pH regulator in an amount of from 0.01 to 5 wt %.

13. The ink for fabric printing according to claim 1, wherein the pH regulator is selected from the group consisting of triethanolamine, diethanolamine, tris(hydroxymethyl)aminomethane, and sodium carbonate.

14. A process for manufacturing a printed matter, comprising:
a printing step, in which printing is performed by causing the ink for fabric printing according to claim 1 to adhere to a fabric; and
a fixing step, in which the ink for fabric printing applied to the fabric in the printing step is fixed to the fabric by heating.
